(19) United States
(12) Patent Application Publication
(10) Pub. No.: US 2026/0341964 A1
(43) Pub. Date: Oct. 29, 2026

(54) LOW PROFILE, CIRCULAR POLARIZED, MULTI-BAND, DIRECTED ANTENNA

(71) Applicant: Field Theory Inc., Vernon Hills, IL (US)

(72) Inventors: Tadd Scarpelli, Vernon Hills, IL (US); Guilherme Jurgensen, Vernon Hills, IL (US); Zabed Iqbal, Vernon Hills, IL (US); Elizabeth Iwanski, Vernon Hills, IL (US)

(73) Assignee: Field Theory Inc., Vernon Hills, IL (US)

(21) Appl. No.: 19/415,431

(22) Filed: Dec. 10, 2025

Related U.S. Application Data
(60) Provisional application No. 63/730,309, filed on Dec. 10, 2024.

(51) Int. Cl. H01Q 9/04; H01Q 5/357

(52) U.S. Cl. CPC H01Q 9/0428; H01Q 5/357

(57) ABSTRACT

A single-feed, multi-band, circularly polarized patch antenna and antenna arrays are disclosed, suitable for applications such as GPS anti-jamming. The antenna comprises a radiative patch element disposed above a ground plane. The patch element includes a plurality of tuning features, such as slots, notches, and cutouts, which increase surface current paths to achieve miniaturization and create multiple resonant frequencies from a single feed point. In one embodiment, the element features include semicircular edge notches, concentric arc slots, a central flanged slot, and a grounding via. In another embodiment, the element includes a triangular cutout extending from the periphery, which enables circular polarization. The direction of polarization (RHCP or LHCP) is selectable based on the location of a feed point relative to the triangular cutout. This embodiment may further include an offset circular slot, a cross slot, and a set of ‘L’-shaped and parallel slots to independently tune the resonant frequencies.

### CROSS-REFERENCE TO RELATED APPLICATIONS

This patent application claims the benefit of U.S. Provisional Patent Application No. 63/730,309, filed Dec. 10, 2024, which is incorporated by reference.

### BACKGROUND OF THE INVENTION

There is a need for an antenna device capable of null-steering for Global Positioning System (GPS) anti-jamming applications. These devices typically require multiple radiating antenna elements to obtain the degree of pattern reconfigurability needed to perform accurate detection. While such solutions do exist, there is the added complexity of trying to reduce the system's overall dimensions as much as possible. This results in a need for electrically smaller antenna elements to maintain sufficient separation to minimize coupling, while balancing the loss in efficiency due to miniaturization.

Typically, dual-band GPS antennas are available as stacked rectangular patches on a ceramic substrate to provide miniaturization with two corners cut along a diagonal to create Right Hand Circular Polarization (RHCP). These antennas will often include a low-noise amplifier (LNA) as part of the base Printed Circuit Board (PCB) as their efficiency after miniaturization is typically too low.

GPS anti-jamming arrays in a similar form factor also utilize patch antenna designs, as they can maintain a low profile. One existing solution provided by L3Harris™ provides a 7-port array in a 7″×7″ package, however it consists of 4 main elements and 3 auxiliary elements with reduced performance, as shown at <https://www.l3harris.com/sites/default/files/2020-11/antenna-n100-6-sas.pdf>.

In the GPS context, existing solutions avoiding miniaturization typically have larger antenna elements, which become difficult to integrate into a compact array. Also, solutions that miniaturize via substrates with high dielectric constants (such as ceramic) tend to have high loss, and solutions seeking dual-band circular polarization often employ the use of two feeds or a stacked patch design. Accordingly, there is a need for a single-fed, multi-band, circularly polarized, miniaturized patch antenna. Further, while such a patch antenna is suitable for GPS applications, other such applications exist.

### SUMMARY OF THE INVENTION

The following summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In one aspect, the disclosure provides a patch antenna element. The element may comprise a slot, such as a slot disposed along a center of the patch antenna element, and a rod, such as a rod connected to a grounded pad and disposed adjacent to the slot.

In another aspect, a multi-band, circularly polarized patch antenna is provided. The antenna may comprise a pad, a plurality of radiative patch elements, and a dielectric substrate disposed between the pad and the plurality of radiative patch elements. In this aspect, each of the radiative patch elements may comprise a slot disposed along a center of the radiative patch element and a rod connected to the pad and disposed adjacent to the slot.

In yet another aspect, a single-feed, multi-band, circularly polarized patch antenna is provided. The antenna may comprise a circular pad, a circular radiative patch element, and a dielectric substrate disposed between the circular pad and the circular radiative patch element. The circular radiative patch element may comprise a first semicircular notch at a first edge location and a second semicircular notch at an opposite edge location. The element may further comprise a first arc slot disposed concentrically from the first semicircular notch, a second arc slot disposed concentrically from the second semicircular notch, a center slot disposed along a center of the element, and a via connected to the circular pad. The center slot may be the largest slot, flanged at its ends, and perpendicular to a diagonal drawn by the notches.

In still another aspect, a patch antenna element is provided. The element may comprise a triangular cutout extending from a periphery to a center point of the patch antenna element and a circular slot disposed along a length of the triangular cutout, which may be offset from the center point.

In another aspect, a multi-band, circularly polarized patch antenna is provided, comprising a pad, a plurality of radiative patch elements, and a dielectric substrate. Each element may comprise a triangular cutout extending from its periphery to its center point and a circular slot disposed along the length of the triangular cutout.

In a further aspect, a single-feed, multi-band, circularly polarized patch antenna is provided, comprising a dielectric substrate and a circular radiative patch element disposed on the substrate. The element may comprise a triangular cutout, a circular slot offset from the center, a cross slot through the triangular cutout, an “L” shaped slot, and a separate slot arranged parallel to one arm of the “L” shaped slot. A feed point may be located next to the triangular cutout, with its position on a first side or a second side determining the polarization (e.g., RHCP or LHCP).

Further aspects and advantages of the invention will become apparent from the detailed description that follows.

### BRIEF DESCRIPTION OF THE SEVERAL VIEWS OF THE DRAWING(S)

FIG. 1 is a patch antenna in accordance with a particular embodiment of the disclosure;

FIG. 2 is an individual patch antenna element of the patch antenna of FIG. 1;

FIG. 3 is a patch antenna in accordance with another embodiment of the disclosure; and

FIG. 4 is an individual patch antenna element of the patch antenna of FIG. 3.

### DETAILED DESCRIPTION OF THE INVENTION

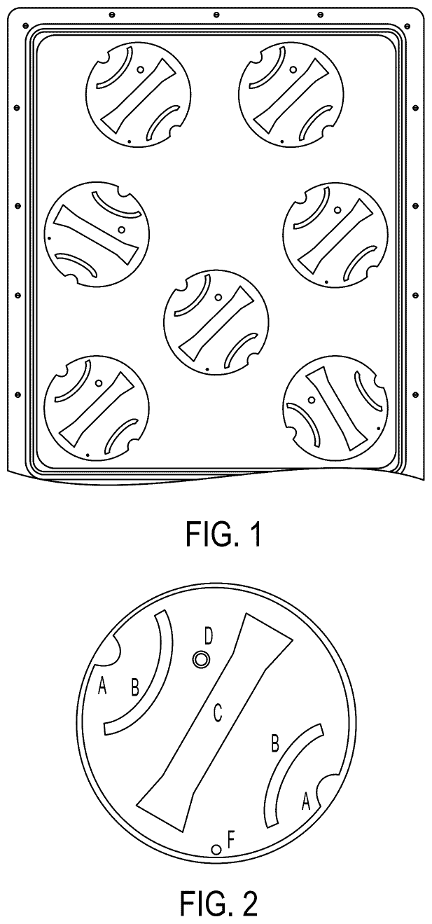

The antenna designs illustrated in FIGS. 1-4 provide a single-feed, multi-band, circularly polarized antenna to be used for various applications, such as GPS. In the GPS context, existing solutions avoid miniaturization and therefore typically have larger antenna elements, which become difficult to integrate into a compact array. Alternatively, solutions that miniaturize via substrates with high dielectric constants (such as ceramic) tend to have high loss, and solutions seeking multi-band circular polarization often employ the use of two feeds or a stacked patch design. Accordingly, what is needed is a single-feed, multi-band, circularly polarized, miniaturized antenna, as shown in the various embodiments of the disclosure discussed below.

FIG. 1 illustrates a particular embodiment of a patch antenna array consisting of seven circular radiative patch antenna elements arranged in an “A” formation. Each of the radiative patch elements include certain design features that enable the patch antenna to be single-fed, multi-band, circularly polarized, and miniaturized. The patch antenna elements are disposed above a ground plane with a dielectric material between the patch antenna elements and the ground plane. In this manner, the dielectric material fills a gap between each of the patch elements and the ground plane.

FIG. 2 illustrates an individual radiative patch element of FIG. 1. In the illustrated embodiment, the patch antenna element is a 30 mm circular patch resonant at L1 (1575.4 MHz, in a particular embodiment) and L2 (1227.6 MHz, in a particular embodiment). The radiative patch element contains: two semicircular notches (A) cut out from the edge of the patch, aligned radially around the center point; two arc slots (B) placed concentrically from the semicircular notches; one larger slot (C) flanged at the ends and placed along the center of the patch and perpendicular to the diagonal drawn by the semicircular notches (A); and a rod (D) making contact with a pad which is separated by the remainder of the patch by a gap.

In a particular embodiment, the rod (D) is a via extending from the individual radiative patch element to the pad. The pad is the ground plane of the patch antenna, and the gap is formed by the dielectric material between the patch elements and the ground plane.

The above features (A)-(D) miniaturize the patch antenna by increasing the surface current paths along each radiative element of the patch antenna. The position of each element (A)-(D) relative to a feed point (F) produces a secondary resonance L2, and each of these features can be tuned in combination with the pad diameter to control the resonances at the L1 and L2.

With respect to tuning each patch element, increasing a length of the center slot (C) separates the two resonances L1 and L2 by moving the L2 resonance down in frequency while holding the L1 resonance constant. Increasing the diameter of the rod (D) lowers the resonant frequency of both L1 and L2 resonances, while slightly decreasing overall efficiency, and increasing the rod gap raises the resonant frequency of both resonances L1 and L2, while increasing overall efficiency. Additionally, changing the location of the rod (D) within a neighboring region of the illustrated location allows for fine tuning of the L1 resonance.

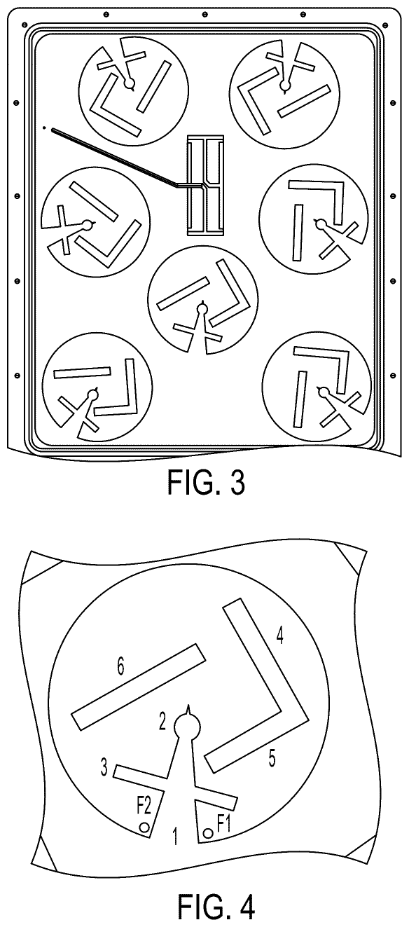

FIG. 3 illustrates another embodiment of a single-feed, multi-band, circularly polarized, miniaturized patch antenna. In the illustrated embodiment, seven circular radiative patch antenna elements are provided and arranged in an “A” formation. Each of the radiative patch elements include certain design features that enable the patch antenna to be single-fed, multi-band, circularly polarized, and miniaturized.

In the illustrated embodiment, the seven patch elements are disposed above a ground plane with a dielectric material disposed between the patch elements and the ground plane. In this manner, the dielectric material fills a gap between each of the radiative patch elements and the ground plane.

In a particular embodiment, each patch antenna element is a 30 mm circular patch resonant at frequencies L1 (1575.4 MHz, in a particular embodiment) and L2 (1227.6 MHz, in a particular embodiment). To achieve the multi-band, miniaturized, and circular polarized functionality of the patch antenna of FIG. 3, each patch element includes several features that are used to tune the resonance and polarization of the patch antenna.

FIG. 4 illustrates an individual radiative patent antenna element showing features [1]-[6]. Features [1]-[6] may be tuned collectively in order to make the patch antenna of FIG. 3 single-fed, multi-band, circularly polarized, and miniaturized and also control the resonances at frequencies L1 and L2.

As shown in FIG. 4, a triangular cutout [1] extends from a periphery to a center point of the patch element. This triangular cutout [1] enables circular polarization of the patch antenna. A direction of the polarization can be selected based on a location of an antenna feed point F1 or F2. The feed point located at F1 produces a Right Hand Circular Polarization (RHCP) for the patch antenna. Alternatively, the feed point located at F2 produces a Left Hand Circular Polarization (LHCP) for the patch antenna. As such, a direction for the circular polarization of the patch antenna can be selected based on the location of the feed point about the triangular cutout [1].

A circular slot [2] is disposed along the length of the triangular cutout [1]. Placing the circular slot [2] along the triangular cutout [1] with an offset from the center of the patch element miniaturizes the patch antenna and controls the resonance at the L2 frequency.

A cross slot [3] disposed across the triangular cutout [1] increases a current path along the perimeter of the triangular cutout [1]. Increasing this current path functions to miniaturize the patch element and still achieve resonance at both the L1 and L2 frequencies.

A slot [4] controls the L1 frequency. In the illustrated embodiment, slot [4] is arranged to be perpendicular to a strong current distribution of the patch element at the L1 frequency. This arrangement along with a length and width of the slot [4] determine the resonance at the L1 frequency.

Slot [5] and slot [6] collectively control the resonance at the L2 frequency. Slot [5] extends perpendicular from an end of slot [4] and is arranged in a parallel configuration to slot [6]. In this arrangement, slots [5] and [6] are in a perpendicular orientation with a strong current distribution of the patch element at the L2 frequency. This arrangement along with a width and length of both slots [5] and [6] determine the resonance at frequency L2.

Other embodiments of the patch antennas illustrated in FIGS. 1-4 are contemplated. In these other embodiments, there may be more or fewer radiative patch elements, with different geometric configurations other than circular and with other design features. The illustrated embodiments are merely specific embodiments of the disclosure, and other embodiments with fewer or modified design features are contemplated. Moreover, the embodiments of the patent antennas discussed herein are in relation to GPS applications. However, other potential applications exist for a single-fed, multi-band, circularly polarized, and miniaturized patch antenna. Accordingly, the disclosure contained herein is not so limited to only the GPS application. Indeed, other size and geometric configurations are contemplated to achieve other design and engineering purposes, such as achieving different resonant frequencies and such other engineering considerations.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A patch antenna element, comprising:
a slot disposed along a center of the patch antenna element; and
a rod connected to a grounded pad and disposed adjacent to the slot.

2. A multi-band, circularly polarized patch antenna, comprising:
a pad;
a plurality of radiative patch elements; and
a dielectric substrate disposed between the pad and the plurality of radiative patch elements;
wherein each of the radiative patch elements comprises:
a slot disposed along a center of the radiative patch element; and
a rod connected to the pad and disposed adjacent to the slot.

3. A single-feed, multi-band, circularly polarized patch antenna array, comprising:
a circular pad;
a circular radiative patch element; and
a dielectric substrate disposed between the circular pad and the circular radiative patch element;
wherein the circular radiative patch element comprises:
a first semicircular notch disposed at a first edge location of the circular radiative patch element;
a second semicircular notch disposed at a second edge location of the circular radiative patch element, wherein the first edge location and the second edge location are disposed oppositely about a center point of the circular radiative patch element;
a first arc slot disposed concentrically from the first semicircular notch;
a second arc slot disposed concentrically from the second semicircular notch;
a center slot disposed along a center of the circular radiative patch element; and
a via connected to the circular pad and disposed in a via location between the first arc slot and the center slot.

4. The single-feed, multi-band, circularly polarized patch antenna of claim 3, wherein the center slot is a largest slot of the circular radiative patch element.

5. The single-feed, multi-band, circularly polarized patch antenna of claim 4, wherein the center slot is flanged at distal ends of the center slot.

6. The single-feed, multi-band, circularly polarized patch antenna of claim 5, wherein the center slot is perpendicular to a diagonal drawn by the first semicircular notch and the second semicircular notch.

7. The single-feed, multi-band, circularly polarized patch antenna of claim 3, further comprising a feed point disposed at an edge location of the circular radiative patch element between a distal end of the center slot and a distal end of the second semicircular notch.

8. The single-feed, multi-band, circularly polarized patch antenna of claim 3, wherein the patch antenna is resonant at a first frequency and a second frequency, and the first frequency is higher than the second frequency.

9. The single-feed, multi-band, circularly polarized patch antenna of claim 8, wherein increasing a length of the center slot decreases the second frequency without affecting the first frequency.

10. The single-feed, multi-band, circularly polarized patch antenna of claim 8, wherein increasing a diameter of the circular pad lowers the first frequency and the second frequency.

11. The single-feed, multi-band, circularly polarized patch antenna of claim 8, wherein increasing a gap between the circular pad and the circular radiative patch element raises the first frequency and the second frequency.

12. The single-feed, multi-band, circularly polarized patch antenna of claim 8, wherein moving the via location between the first arc slot and the center slot tunes the first frequency.

13. A patch antenna element, comprising:
a triangular cutout extending from a periphery to a center point of the patch antenna element; and
a circular slot disposed along a length of the triangular cutout.

14. The patch antenna element of claim 13, wherein the circular slot is offset from the center point of the patch element.

15. A multi-band, circularly polarized patch antenna array, comprising:
a pad;
a plurality of radiative patch elements; and
a dielectric substrate disposed between the pad and the plurality of radiative patch elements;
wherein each radiative patch element of the plurality of radiative patch elements comprises:
a triangular cutout extending from a periphery to a center point of the radiative patch element; and
a circular slot disposed along a length of the triangular cutout.

16. The multi-band, circularly polarized patch antenna array of claim 15, wherein the circular slot is offset from the center point of the radiative patch element for each of the plurality of radiative patch elements.

17. A single-feed, multi-band, circularly polarized patch antenna, comprising:
a dielectric substrate; and
a circular radiative patch element disposed on top of the dielectric substrate;
wherein the circular radiative patch element comprises:
a triangular cutout extending from a periphery of the circular radiative patch element to a center of the circular radiative patch element;
a circular slot disposed along the triangular cutout and offset from the center of the circular radiative patch element;
a cross slot through the triangular cutout;
an “L” shaped slot comprising a first slot arm and a second slot arm perpendicular to the first slot arm both disposed on a first side of the triangular cutout of the circular radiative patch element; and
a slot separate from the “L” shaped slot, the slot is arranged perpendicular to the first slot arm and parallel to the second slot arm.

18. The single-feed, multi-band, circularly polarized patch antenna of claim 17, further comprising a feed point, wherein the feed point is located at an edge of the circular radiative patch element and next to the triangular cutout.

19. The single-feed, multi-band, circularly polarized patch antenna of claim 18, wherein the feed point is located on the first side of the triangular cutout, and the patch antenna is Right-Hand Circular Polarized.

20. The single-feed, multi-band, circularly polarized patch antenna of claim 18, wherein the feed point is located on a second side of the triangular cutout opposite the first side of the triangular cutout, and the patch antenna is Left-Hand Circular Polarized.

21. The single-feed, multi-band, circularly polarized patch antenna of claim 18, wherein the patch antenna is resonant at a first frequency and a second frequency, and the first frequency is lower than the second frequency.

22. The single-feed, multi-band, circularly polarized patch antenna of claim 21, wherein a location of the circular slot disposed along the triangular cutout and offset from the center of the circular radiative patch element tunes the second frequency and miniaturizes the circular radiative patch element at the second frequency.

23. The single-feed, multi-band, circularly polarized patch antenna of claim 21, wherein cross slot miniaturizes the circular radiative patch element at both the first frequency and the second frequency.

24. The single-feed, multi-band, circularly polarized patch antenna of claim 21, wherein a width and length of the first slot arm of the “L” shaped slot tunes the first frequency.

25. The single-feed, multi-band, circularly polarized patch antenna of claim 21, wherein a width and length of the second slot arm of the “L” shaped slot tunes the second frequency.

26. The single-feed, multi-band, circularly polarized patch antenna of claim 21, wherein a width and length of the slot tunes the second frequency.
